(19) United States
(12) Patent Application Publication
(10) Pub. No.: US 2016/0360766 A1
(43) Pub. Date: Dec. 15, 2016

(54) APPARATUS AND METHOD FOR COOLING PERISHABLE GOODS

(71) Applicant: Frederic R. Weeth, Pacific Grove, CA (US)

(72) Inventor: Frederic R. Weeth, Pacific Grove, CA (US)

(21) Appl. No.: 14/738,480

(22) Filed: Jun. 12, 2015

(51) Int. Cl. A23B 7/04

(52) U.S. Cl. CPC A23B 7/04; A23V 2002/00

(57) ABSTRACT

An apparatus and method are disclosed for cooling perishable goods including fruits and vegetables, such as for example grapes. The apparatus includes an air bypass prevention dam having a tarp for covering exposed surfaces of the containers of the perishable goods. The tarp may include wedges to prevent the containers from collapsing into a central space as air is forced through the containers. The air bypass prevention dam further includes a rigid restraint structure affixed to the tarp for preventing the tarp from being pushed away from the containers as air is forced through the containers.

### BACKGROUND

When transporting temperature controlled, perishable goods such as fruits and vegetables, it is typically important to their quality and safety to maintain a cold chain from harvest, through the distribution chain to the final customer. The term “cold chain” refers to the uninterrupted temperature management of perishable goods in order to maintain quality and safety from the point of post-harvest cooling through the distribution chain to the final consumer. The cold chain ensures that perishable product are safe and of high quality at the point of consumption.

Typically, perishable goods such as fruits and vegetables may be harvested into trucks which carry the produce to fixed-base cooling facilities, where the produce is cooled and the cold chain begins. The produce is then transported from the cooling facilities to their final destination, often in refrigerated semi-trailers called reefers. Fixed-base cooling facilities typically used forced air cooling systems where palletized containers of freshly-harvested produce are stacked, typically in two spaced apart rows and columns. Suction fans at a rear section of the containers thereafter force cooled air in the facility between the stacked produce into the central space. Conventionally, top and rear sections of the containers are covered with a thin sheet of material to prevent bypass of cooled air around the containers (over the top of the containers into the central space or in through the front opening of the central space) instead of through the containers.

This type of cooling of produce has several drawbacks. For example, the structure of the containers is relied on to maintain the stacks in a stable, fixed position as cooled air is suctioned through the containers. However, given the relatively high stacks of containers that are used, and the high pressure differential on opposed sides of the containers, the stacks of containers often collapse into the central space. In addition to potentially damaging the produce, collapse of the containers requires a stoppage in cooling and significant time and effort to retrieve and re-stack the containers. It is known to deal with this problem by running the suction fans at a low speed to prevent large pressure differentials across the containers. This, however, results in less effective cooling of the produce.

Another drawback to conventional fixed-based facility cooling systems is that the suction fans pull cooled air through one side of the containers. Thus, produce on that side of the containers is more effectively cooled than the produce on the side of the container facing the central space. While it is conceivable that air flow from the fans may be reversed, creating a positive pressure in the central space, the relatively flimsy sheet of material covering the top and rear of the stacked containers would be blown off, providing an escape for the cooled air to bypass flow through the containers.

### DESCRIPTION OF THE DRAWINGS

FIG. 1 is a perspective view of an apparatus according to embodiments of the present technology.

FIG. 2 is a perspective view of a structural frame of an apparatus according to embodiments of the present technology.

FIG. 3 is a perspective view of a top dam of an apparatus according to embodiments of the present technology.

FIG. 4 is a bottom view of a top dam of an apparatus according to embodiments of the present technology.

FIG. 5 is a front view of an apparatus cooling perishable goods according to embodiments of the present technology.

FIG. 6 is a perspective view of an air bypass prevention dam in a deployed position according to embodiments of the present technology.

FIG. 7 is a perspective view of an air bypass prevention dam in a stowed position according to embodiments of the present technology.

FIG. 8 is a side view of an apparatus cooling perishable goods according to embodiments of the present technology.

FIG. 9 is a schematic representation of two modes of air flow operation according to embodiments of the present technology.

FIG. 10 is a front view showing a pallet dam for blocking air through two different standard pallet heights according to embodiments of the present technology.

### DETAILED DESCRIPTION

The present technology will now be described with reference to the figures, which in embodiments relates to an apparatus and method for cooling perishable goods including fruits and vegetables, such as for example table grapes. However, it is understood that the technology described herein may be used to cool a variety of other perishable goods where the goods are stored, transported and/or handled in a controlled temperature environment. Such temperature controlled goods include but are not limited to fruits, vegetables, meat, poultry, plants, flowers, chemicals, pharmaceuticals, blood and other body fluids and tissue. In embodiments, the present system may be used in a fixed-base cooling facility where perishable goods are brought after harvesting. However, it is understood that the present system may be used in other facilities and situations, at any point during the cold chain for perishable goods.

The present technology may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The terms “top” and “bottom,” “upper” and “lower,” “vertical” and “horizontal” and “distal” and “proximal,” and “front” and “rear” as may be used herein are by way of example and illustrative purposes only, and are not meant to limit the description of the invention inasmuch as the referenced item can be exchanged in position and orientation. Also, as used herein, the terms “substantially” and/or “about” mean that the specified dimension or parameter may be varied within an acceptable manufacturing tolerance for a given application. In one embodiment, the acceptable manufacturing tolerance is ±0.25%.

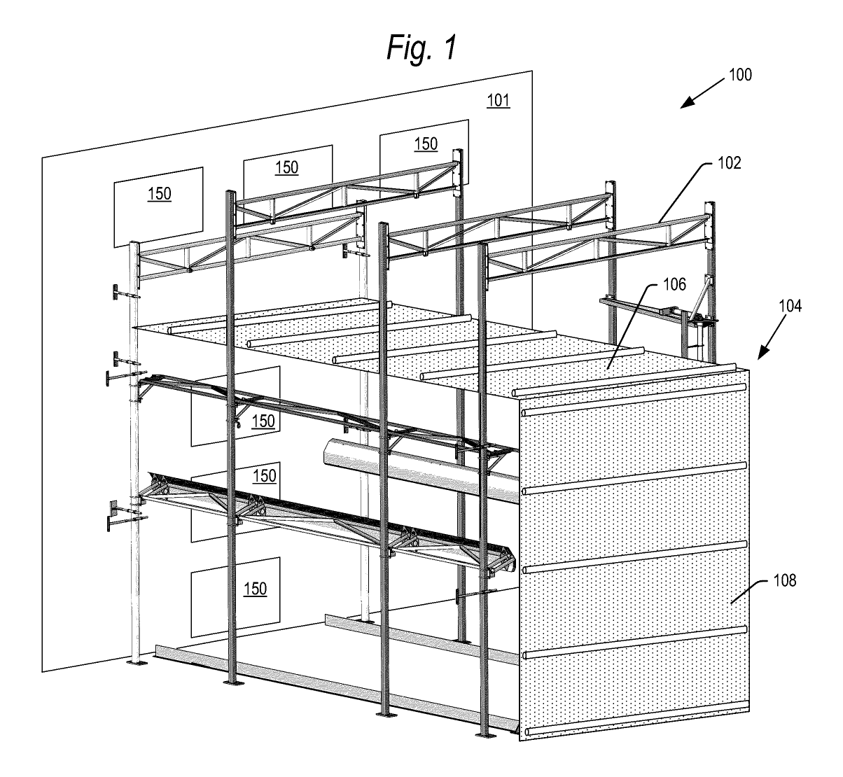

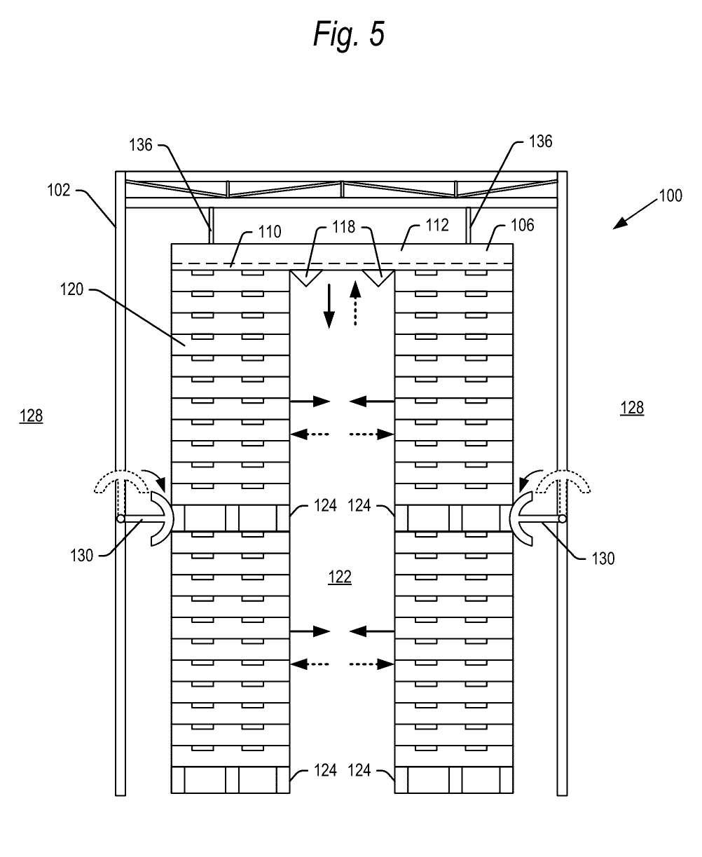

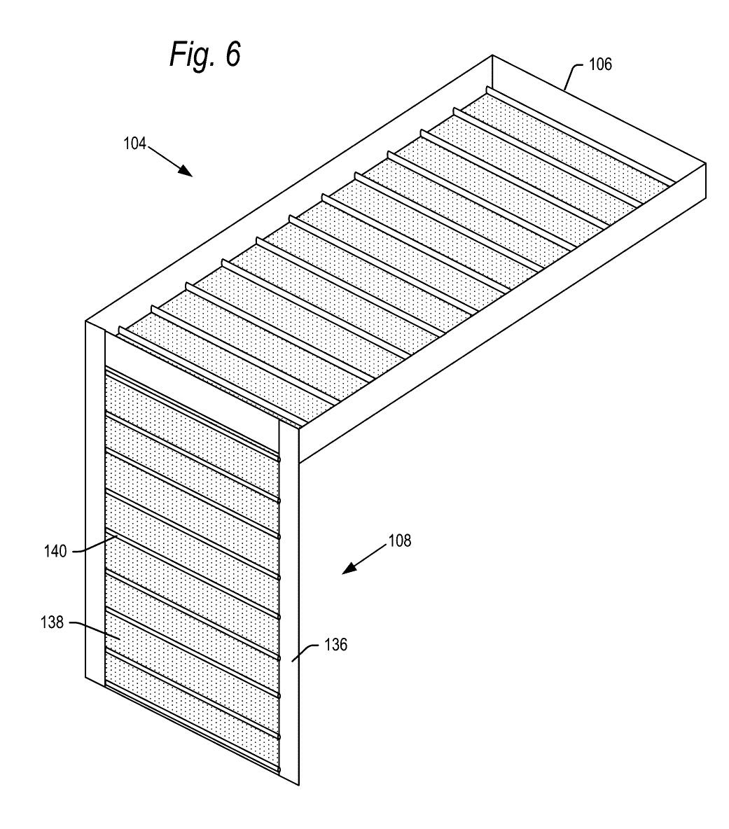

FIG. 1 illustrates a perspective view of an apparatus 100 for cooling perishable goods, for example within a fixed-base cooling facility. The apparatus 100 may be adjacent a wall 101, referred to herein as a rear wall 101, including fan units 150 for circulating cooled air to containers positioned within the apparatus 100 as explained hereinafter. For ease of description only, containers within apparatus 100 near the wall 101 may be referred to as rear containers, while the containers within apparatus 100 most distal from the rear wall 101 may be referred to as front containers. The apparatus shown in FIG. 1 includes a structural frame 102 and an air bypass prevention dam 104 comprising a top dam 106 and a front dam 108. The air bypass prevention dam 104 may be mounted to the structural frame by support brackets 136 on top of containers 120, omitted from FIG. 1. The support brackets 136 and containers 120 are shown for example in FIG. 5.

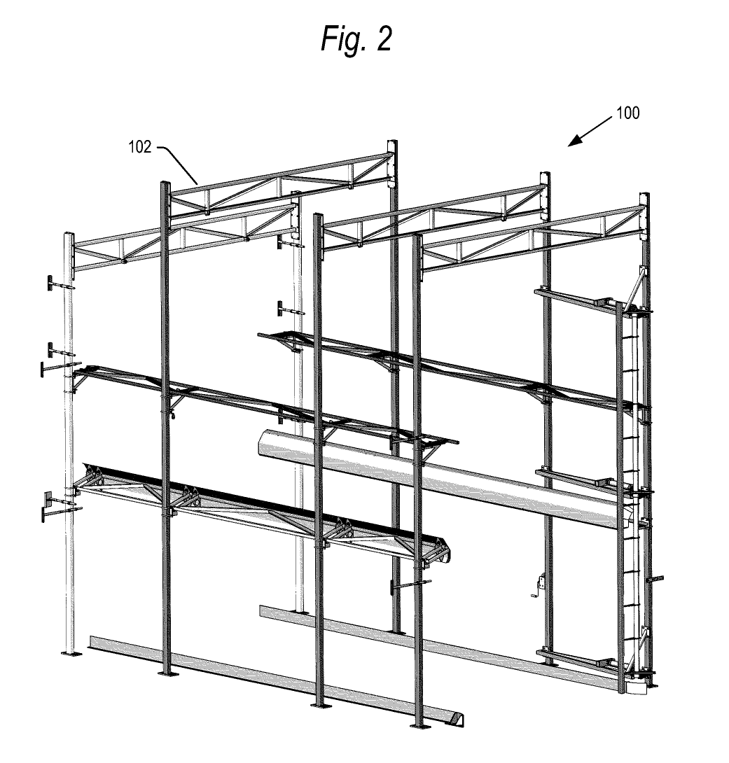

FIG. 2 illustrates a perspective view of the structural frame 102 of the apparatus 100 without the air bypass prevention dam 104. In embodiments, structural frame 102 may include a variety struts, support braces and/or trusses provided for the purpose of supporting the air bypass prevention dam 104 in position relative to perishable goods being cooled as explained hereinafter. In embodiments, the structural frame may be formed of metal components, but wood or other rigid materials may be used in addition to, or instead of, the metal components in further embodiments. The number and particular configuration of struts, support braces and/or trusses shown in FIGS. 1 and 2 is by way of example only. It is understood that the structural frame 102 may be configured in a wide variety of different ways with the provision that the structural frame support the air bypass prevention dam 104 as explained hereinafter. The various components of structural frame 102 may be screwed, bolted, glued and/or welded to each other. The components of structural frame 102 may also be adjustable to handle container loads of different dimensions. In further embodiments, structural frame 102 may be formed of a single unitary construction.

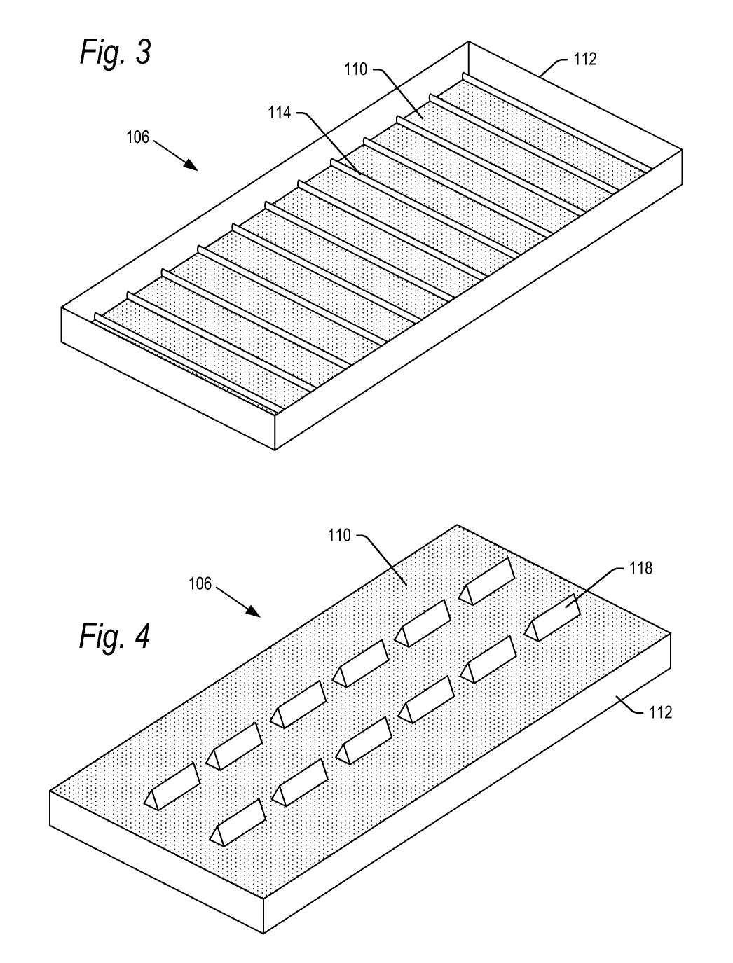

The perspective views of FIGS. 3 and 4 show top and bottom views, respectively, of the top dam 106 of the air bypass prevention dam 104. The top dam 106 may include a tarp 110 affixed around its perimeter edges to a framing member 112. The tarp 110 may be formed of a variety of flexible, durable materials including for example fabric, canvas, vinyl, polyethylene and other plastics. The tarp 110 may be formed of other materials in further embodiments. The framing member 112 may be formed of metal, wood or other materials, and the tarp 110 may be affixed to the framing member 112 with for example screws or bolts.

A number of rigid rods 114 (one of which is numbered in FIG. 3) may be affixed to the tarp 110 and/or framing member 112. The rods 114 may be formed of a substantially rigid material, such as for example fiberglass and other plastics, wood or metal. As explained hereinafter, the rods 114 and framing member 112 are provided to maintain the tarp 110 against an upper surface of containers carrying perishable goods to prevent the bypass of cooled air above the containers instead of through the containers. It is understood that the rods 114 may be provided in a wide variety of configurations to perform this function. In one embodiment, the rods 114 may be oriented widthwise across a width of the tarp 110. In such an embodiment, the rods 114 may be spaced approximately every 2 feet each other along the entire length of the tarp 110. It is understood that the rods 114 may have different spacing along the length of the tarp 110 in further embodiments. The rods 114 may be affixed to the tarp 110, for example within fabric sleeves sewn onto or otherwise affixed to the tarp 110. The rods may alternatively or additionally be affixed to framing member 112, for example as with screws or bolts, in further embodiments.

The rods 114 may be oriented lengthwise along the length of tarp 110 in further embodiments, or in a crosshatch pattern parallel to the length and width of the edges of the tarp 110, or oriented at some oblique angle with respect to the edges of tarp 110. Instead of rods 114, some other rigid restraint structure may be used, such as for example a lattice of rigid members or a solid rigid sheet. In embodiments including rods or other rigid restraint structure, it is conceivable that the framing member 112 may be omitted, such as for example as shown in FIG. 1.

FIG. 4 is a bottom perspective view of top dam 106. As shown, a number of wedges 118 (one of which is numbered in FIG. 4) may be affixed to the tarp 110. The wedges 118 may be aligned in two rows, lengthwise along the tarp. The wedges 118 are provided to engage the upper row of two spaced apart groups of containers as explained below, to prevent the containers from collapsing into a central space separating the containers when air is suctioned from the central space. Accordingly, the spacing between the two rows of wedges may be determined by the spacing between the two groups of containers to be cooled, or vice-versa (the spacing of the two groups of containers may be determined by the spacing of the two rows of wedges). In one embodiment, the two rows of wedges may be spaced 40 inches from each other. As noted, the spacing may be greater or lesser than that in further embodiments.

In one example, each group of containers loaded in apparatus 100 may have six columns of containers. Thus, in the example shown in FIG. 4, there are six wedges 118 in each row. In one example, each wedge may be 3 feet long and spaced apart 1 foot from the next adjacent wedge 118. These dimensions are by way of example only, and may vary in further embodiments. For example, there may be fewer or greater wedges in a row than there are columns of containers in each group. In one example, the wedge 118 in each row may have a single continuous length along most or all of the tarp 110.

The wedges 118 may be formed of various rigid or semi-rigid materials including for example rubber, plastic, foam rubber and wood. The wedges 118 may be formed of other materials in further embodiments. The wedges 118 may be affixed to a bottom surface of the tarp 110 by screws, glue or fitting within one or more sleeves sewn into the bottom surface of the tarp 110.

In embodiments, the wedges 118 may have a shape in cross-section of an equilateral or isosceles triangle. In one embodiment, a base portion adjacent the tarp 110 may have a width of 2.5 inches, and the sides extending therefrom may be 2 inches long. (The wedges are shown in the figures for clarity and may not be drawn to scale). These dimensions are by way of example only, and may vary in further embodiments. A triangular shape of the wedge has benefits in that it provides tolerance in cases where the tarp 110 comes down on top of the top row of containers such that one or both rows of wedges contact containers along their angled surfaces. In this instance, contact with the angled surfaces will force to containers outward into a correct vertical position as a tarp 110 is pulled downward onto the tops of the containers. However, it is understood that the wedges 118 may have other cross-sectional shapes in further embodiments, including for example a triangle with uneven sides, circular, oval, square and trapezoidal.

FIG. 5 is a front view of two groups of containers 120 (one of which is numbered) of perishable goods being cooled within the apparatus 100 according to the present technology. The front dam 108 (explained below) is omitted from FIG. 5 for clarity. The containers 120 may be stacked within the structural frame 102 in first and second groups of containers defining a central space 122 therebetween. In embodiments, the containers 120 may be stacked on pallets 124, with each column in a given group having two pallets of stacked containers. The number of pallets of stacked containers in each group may vary in further embodiments.

As explained below, fan units are provided for suctioning air out of central space 122 in a first mode of operation, and for blowing air into the central space 122 in a second mode of operation. In the first mode of operation, the tarp 110 of the top dam 106 is pulled in the direction of the solid vertical arrow into contact with the upper containers 120 in the first and second groups of containers. This contact prevents bypass of cooled air from a surrounding environment 128 around a top of the containers and top of the central space 122, and instead forces the cooled air from environment 128 through the containers (in the direction of the solid horizontal arrows). The wedges 118 engage a portion of the top rows of containers, for example vertical portions of the top rows of containers. This contact prevents the groups of containers 120 from collapsing into the central space 122 as a result of the pressure differential between the environment 128 and the central space 122.

In the second mode of operation, the direction of airflow from the fan units is reversed. Air is forced into the central cavity 122 and a force is exerted in the direction of the dashed vertical arrow biasing the tarp 110 away from the containers. The rods 114, or other rigid restraint structure, maintain the tarp 110 in contact with the upper containers 120 in the first and second groups of containers. This contact prevents bypass of cooled air from central space 122 to the surrounding environment 128 around a top of the containers, and instead forces the cooled air into environment 128 through the containers (in the direction of the dashed horizontal arrows).

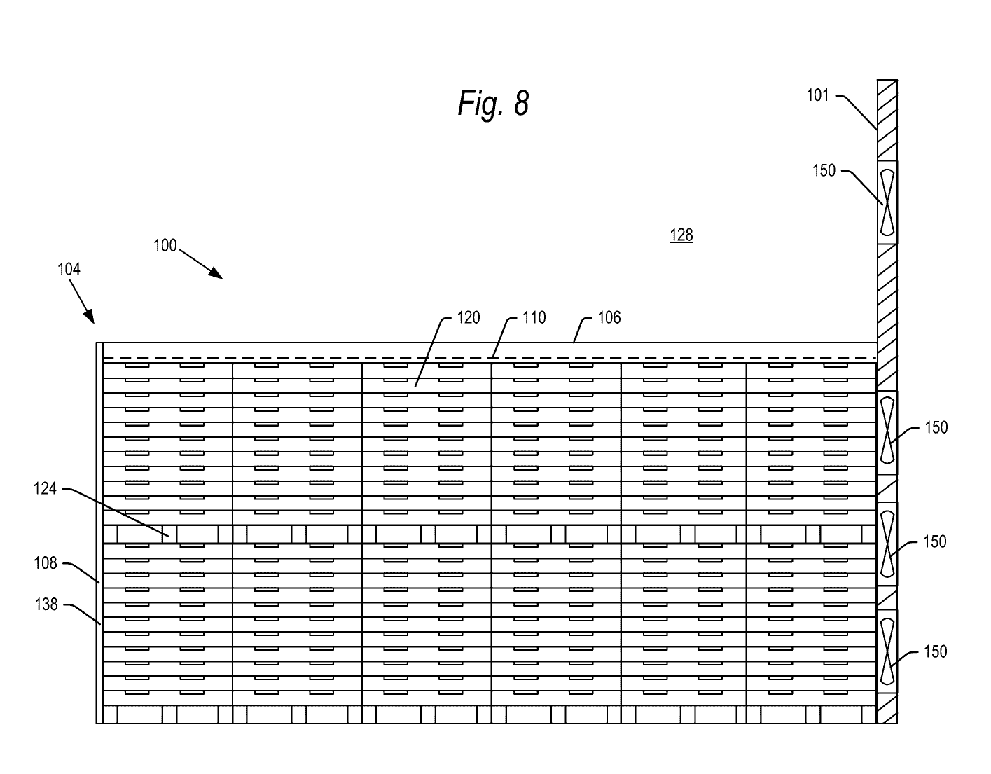

The air bypass prevention dam 104 may be mounted to the structural frame 102 by brackets 136 which allow the dam 104 to pivot and/or translate between stowed and deployed positions. The brackets may comprise pneumatically actuated swing arms driven by a motor (not shown) to move the air bypass prevention dam 104 between the stowed and deployed positions. In the stowed position, the top dam 106 is raised upward, and the front dam 108 is pivoted and/or translated upward as explained below, so that containers may be freely loaded into position within the apparatus 100. Once the containers are loaded, the bypass prevention dam 104 may be moved by the pneumatically actuated swing arms to the deployed position, where the top dam 106 rests against the top level of containers 120 as shown in FIG. 5, and the front dam 108 rests against the front containers 120 as explained below with respect to FIG. 8.

It is understood that the top and/or front dams may be moved to a stowed position by other methods. In one further example, the front dam 108 may be a tarp 138 with no surrounding frame. In such an embodiment, the tarp 138 may be moved to a stowed position by rolling (or otherwise lifting) the tarp 138 upward to a position even with or on top of the top dam 104, where it may be fastened. In further embodiments, the tarp 138 may affixed to the top dam 104 by a rotating spool. The tarp 138 may then be stowed by rotating the spool to wind the tarp around the spool at a position even with or above the top dam 104. Other stowing methods for the top dam 104 an front dam 108 are contemplated.

As noted, containers 120 are stacked on top of pallets 124. The pallets 124 have a largely open air construction through which cooled air can escape from the central space 122 in the first mode of operation or into the central space 122 in the second mode of operation. Therefore, in accordance with a further aspect of the present technology, a pallet dam 130 may be mounted to the structural frame 102 as seen for example in FIGS. 1-2 and 5. In the example of FIG. 5, the pallet dams 130 may be stowed in a vertical position (shown in dashed lines) and then manually or automatedly rotated to a horizontal position in contact with the air gaps of pallets 124 when containers 120 are positioned within structural frame 102. The height of the pallet dams 130 may be adjustable along a height of structural frame 102 to work with pallet positions at different heights. A metal brace (not shown) may prevent rotation of the pallet dams past horizontal to maintain them within the air gaps of pallets 124.

In further embodiments, the pallet dams 130 may not move to a stowed position, but instead may remain extended from the structural frame 102 at a height known to engage a standard height of pallets loaded into the apparatus 100.

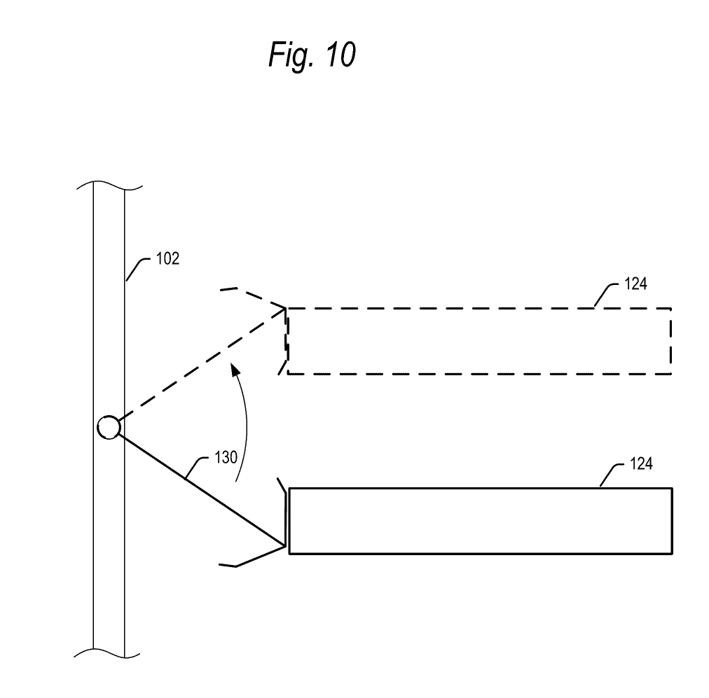

In further embodiments, there may be more than one standard height of pallets loaded into the apparatus 100. For example, it is standard in the table grape industry to stack upper pallets at one of two heights: 82 inches overall (product plus pallet) for containers comprised of cardboard boxes with clamshells, and 90 inches overall for containers comprised of EPS (expanded polystyrene). Therefore, when cooling cardboard with clams the bottom of the top pallet is at 82 inches and when cooling EPS the bottom of the top pallet is at 90 inches. The pallet dam 130 may be provided to rotate between these two heights. FIG. 10 illustrates a further embodiment of a pallet dam 130 for working with two different standard heights.

In FIG. 10, the pallet dam on one side of the frame 102 is shown blocking the air gaps of a pallet 124 with pallet 124 at a first standard height. In order to work with a pallet 124 at a second standard height (shown in dashed lines), the pallet dam 130 may be rotated as indicated by the arrow to a position (shown in dashed lines) where it blocks the air gaps of the pallet 124 at the second standard height. The pallet dam 130 in the opposed wall may be configured and function in the same manner. The pallet dams 130 would be set at the appropriate height for the pallets being used, and then the pallets may be loaded into the apparatus 100.

In this embodiment, the pallet dam may be bent into four planar surfaces as shown in FIG. 10, as opposed to the rounded surface shown in FIG. 5. With this configuration, a first primary planar face may rest against the pallets 124 with the pallet 124 in the first standard height, and a second primary planar face may rest against the pallets 124 with the pallet 124 in the second standard height, as shown in FIG. 10. The secondary bends (at the edges of the pallet dam 130) add strength and help keep the forklift operator from getting the pallets under/over the air dam.

When engaged within the air gaps of pallets 124, the pallet dams 130 prevent bypass airflow through the air gaps of pallets 124. The pallet dams 130 may be provided with a length to cover the air gaps of all pallets loaded within the structural frame 102. While a single pair of pallet dams 130 on opposed sides of frame 102 is shown, it is understood that additional pairs of pallet dams 130 may be provided to block air gaps on other pallets within the structural frame 102 (such as for example the bottom-most pallets 124).

While shown as simply pivoting, it is understood that the pallet dams 130 may additionally or alternatively be mounted for horizontal translation on the structural frame 102 so as to pivot and/or translate into the air gaps of pallets 124. In addition to preventing air bypass through the pallets, the pallet dams 130 also provide structural support to keep the groups of containers in position during the second mode of operation explained below where the pressure within the central space 122 is greater than that of the surrounding environment 128.

A further function of the pallet dams 130 is to serve as a rub rail. When the forklift operator is positioning the top pallet 124, he can side shift so that the pallet 124 is rubbing against the pallet dam 130 as he moves into position. Rubbing against the pallet dam puts the pallet 124 aligned on top of the bottom pallet 124 which has been placed against a floor mounted rub rail (not shown), the upper pallet against the pallet dam 130 to minimized air by-pass, and the top of the pallet correctly positioned relative to the tarp wedge. The floor mounted rub rail, pallet dam, and top rub rail are all in the same vertical plane so the two-high pallet stack has three points of contact the keep the stack from blowing out when cooling air is pushed in the reverse direction.

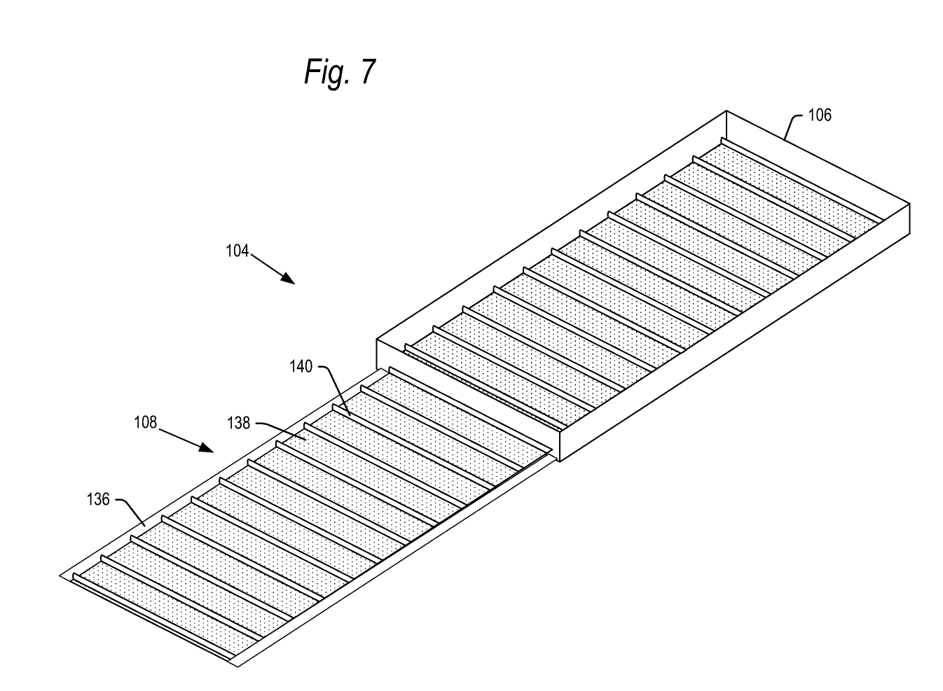

Referring now to the perspective views of FIGS. 1 and 6, the air bypass prevention dam 104 may further include the front dam 108. The front dam 108 may be fixedly or pivotally mounted to the top dam 106, for example to framing member 112. As noted, the air bypass prevention dam 104 may be moved to a stowed position where it allows containers 120 to be loaded into the interior of apparatus 100. Thus, the front dam 108 may be pivotally mounted to framing member 110 to allow it to pivot up out of the way of the containers, as shown for example in FIG. 7. While shown pivoted to a substantially parallel position with the top dam 106 in FIG. 7, the front dam 108 may be pivoted less than that in further embodiments. Once the containers 120 are loaded into position, the top dam 106 may lower down onto the top containers 120, and the front dam 108 may pivot from a horizontal or near horizontal position to a vertical position covering the front containers 120.

The front dam 108 may include a framing member 136 which may be formed of metal or wood. A tarp 138 may be affixed to the framing member, which tarp may include rigid rods 140. The tarp 138 and rods 140 may function as described above with respect to tarp 110 and rods 114, to cover the containers at the front of the loaded groups of containers. The materials of tarp 138 and rods 140 may be the same as or different from the tarp 110 and rods 114 described above. The front dam 108 may have no wedges, but in further embodiments, the front dam 108 may include wedges as described above for engaging the front columns of containers to provide support for the two groups of containers.

FIG. 8 is a side cross-sectional view within central space 122 showing one of the two groups of containers 120 (one of which is numbered) of perishable goods being cooled within the apparatus 100. As noted, in one example, there may be six columns of the containers 120 in one group, stacked side-by-side to prevent bypass of air between the stacked containers. FIG. 8 further shows fan units 150 for circulating cooled air through the containers 120 to cool perishable goods within the containers. The pallet dams 130 and structural frame 102 are not shown in FIG. 8.

In embodiments, there may be three fan units 150 aligned vertically along central space 122 to suction air from the central space 122 in the first mode of operation, and to blow air into the central space 122 in the second mode of operation. There may be greater or lesser than three fan units aligned with the central space 122 in further embodiments. There may also be three fan units aligned horizontally above the structural frame 102 to blow air into the external environment 128 in the first mode of operation, and to suction air from the external environment 128 in the second mode of operation. There may be greater or lesser than three fan units above the frame 102 in further embodiments, and they need not be horizontally aligned in further embodiments.

The tarp 110 in the top dam 106 may have a footprint approximately equal to an outline footprint of the first and second groups of containers 120 together. In one example, the outline footprint of the first and second groups of containers 120 together may be 24 feet in length by 10 feet in width. In such an example, the first and second groups of containers 120 may each have a width of 40 inches, leaving a width a 40 inches for the central space 122. In further embodiments, the width of the tarp 110 in top dam 106 may be slightly narrower than the width dimension of the outline footprint of the containers 120. For example, where the outline footprint with is 10 feet, the width of the tarp 110 in top dam 106 may be 8 feet, 8 inches. These numbers are by way of example only, and the tarp 110 may be narrower than the width dimension of the container outline footprint by more or less than that in further embodiments. The tarp 110 in top dam 106 may also be wider than the width dimension of the container outline footprint in further embodiments. The tarp 138 in the front dam 108 may have the same width as tarp 110, and may extend over a height equal to or greater than the height of the containers in the first and second groups of containers.

In the first mode of operation, the tarp 138 of the front dam 108 is pulled into contact with the front containers 120 in the first and second groups of containers. This contact prevents bypass of cooled air from the surrounding environment 128 around the front containers or through the front of the central space 122, and instead forces the cooled air from the surrounding environment 128 through the containers. In the second mode of operation, the direction of airflow from the fan units 150 is reversed. Air is forced into the central cavity 122 and a force is exerted against the front dam 108 biasing the tarp 138 away from the containers. The rods 140, or other rigid restraint structure, maintain the tarp 138 in contact with the front containers 120 in the first and second groups of containers. This contact prevents bypass of cooled air from central space 122 to the surrounding environment 128 around the front containers or through the front of the central space 122, and instead forces the cooled air into environment 128 through the containers.

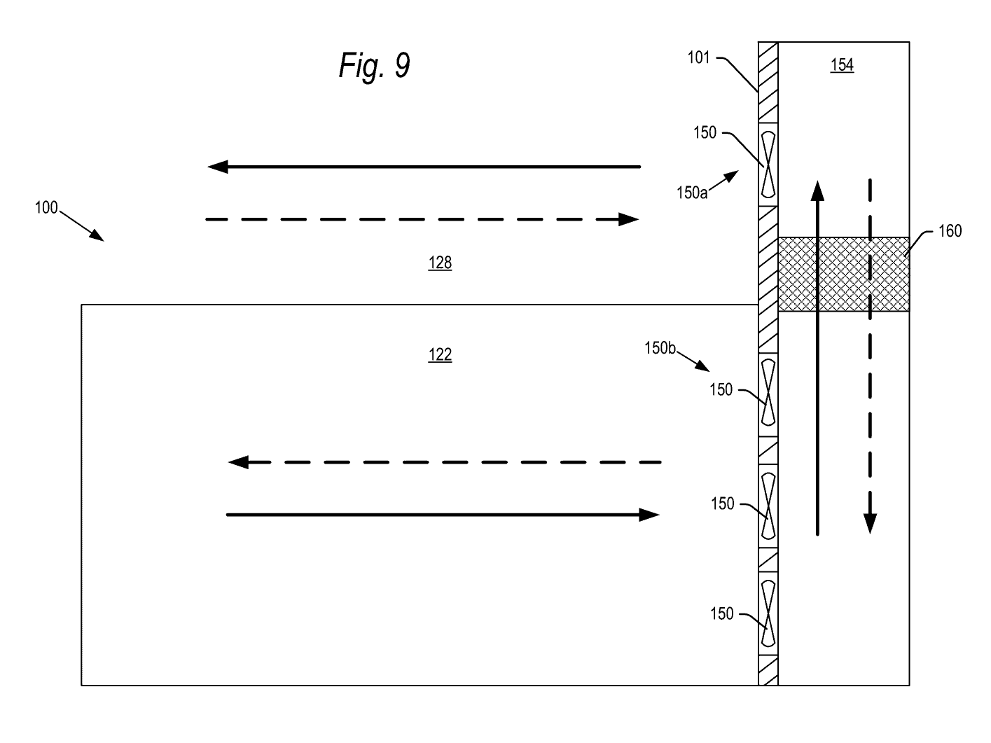

FIG. 9 is a schematic drawing illustrating the first and second modes of operation of the fan units 150 to efficiently and evenly cool perishable goods within containers 120. In the first mode of operation, the fans 150 operate to circulate air in the direction of the solid arrows. Cooled air from the fan units 150 in the upper fan bank 150a is circulated into the external environment 128 from a plenum 154 behind wall 101. The cooled air then passes through the containers 120 into central space 122 to cool the perishable goods within the containers 120 from a first side of the containers. Air is then suctioned from the central space 122 into the plenum 154, where may be re-cooled by a cooling unit 160, such as a heat exchanger, and circulated back into the external environment 128.

In the second mode of operation, the fans 150 operate to circulate air in the direction of the dashed arrows. Cooled air from the fan units 150 in the lower fan bank 150b is circulated into the central space 122 from plenum 154. The cooled air then passes through the containers 120 into external environment 128 to cool the perishable goods within the containers 120 from a second side of the containers. Air is then suctioned from the external environment 128 into the plenum 154, where may be re-cooled by the cooling unit 160 and circulated back into the central space 122.

In addition to the danger of container collapse and air bypass, conventional systems were constrained in their cooling capacity in that running the fans in a single direction resulted in a temperature differential of the perishable goods on opposite sides of the containers. The problem of container collapse, as well as air bypass around the containers, is solved by the air bypass prevention dam 104 as described above. The problem of temperature differential on opposite sides of the containers is solved by reversing the flow of cooled air in the first and second modes of operation.

Thus, apparatus 100 in accordance with the present technology is able to cool perishable goods within containers 120 efficiently and quickly. In one embodiment, the fans 150 may circulate 80,000 ft.³ of air per minute through the containers 120 and central space 122. In such an embodiment, the fans may generate a 2 inch water column pressure differential between the central space 122 and the external environment 128. The tight seal of the air bypass prevention dam 104 and reversing the air flow may reduce cooling cycle times by as much as 50% or more. These flow rates and pressure differentials are by way of example only, and may differ together or independently of each other in further embodiments. The increased air flow rate is also made possible by the operation of the air bypass prevention dam 104 to maintain a good seal around the tops and front of the containers.

FIGS. 1 and 2 illustrate a single apparatus 100 in accordance with the present technology. It is understood that a number of apparatus 100 may be aligned side-by-side against wall 101 and operate individually or in tandem with each other. In such embodiments, each such apparatus 100 may have its own associated lower fan bank 150b. Each such apparatus 100 may also have its own associated upper fan bank 150a, or multiple apparatus 100 may share the fans 150 in an upper fan bank 150a.

In summary, the present technology relates to an apparatus for cooling perishable goods within a plurality of containers, the goods cooled by cooled air forced through the containers, the apparatus comprising: a tarp having first and second surfaces, the tarp comprising: a wedge, affixed to one of the first and second surfaces of the tarp, for engaging a portion of one or more containers to support the plurality of containers against movement due to a pressure differential on opposed sides of the plurality of containers, and a rigid restraint structure, affixed to one of the first and second surfaces of the tarp, for maintaining the tarp against the one or more containers against a force biasing the tarp away from the one or more containers.

In a further example, the present technology relates to an apparatus for cooling perishable goods within containers, the containers stacked in two groups, each group including rows and columns of containers, the two groups of containers defining a central space between the two groups of containers, the goods cooled by cooled air forced through the containers in the two groups of containers, the apparatus comprising: a tarp having first and second surfaces, the tarp comprising: first and second wedges, affixed to one of the first and second surfaces of the tarp, for engaging a portion of one or more containers in each of the two groups of containers, the first and second wedges operable to support the containers in the two groups against movement into the central space due to a pressure differential on opposed sides of the two groups of containers, and a rigid restraint structure, affixed to one of the first and second surfaces of the tarp, for maintaining the tarp against the one or more containers in each of the two groups against a force biasing the tarp away from the one or more containers in the two groups.

In another example, the present technology relates to an apparatus for cooling perishable goods within a plurality of containers, the goods cooled by cooled air forced in a first direction through the containers in a first mode of operation, and the cooled air forced in a second direction through the containers, opposite the first direction, in a second mode of operation, the apparatus comprising: a top dam for engaging horizontal surfaces of a first group of containers, the top dam comprising a first tarp having first and second surfaces, the first tarp comprising: a wedge, affixed to one of the first and second surfaces of the tarp, for engaging a portion of the first group of one or more containers to support the plurality of containers against movement due to a pressure differential on opposed sides of the plurality of containers as air is forced through the plurality of containers in the first direction, and a first rigid restraint structure, affixed to one of the first and second surfaces of the first tarp, for maintaining the first tarp against the horizontal surfaces of the first group of containers against a force biasing the first tarp away from the first group of containers as air is forced through the plurality of containers in the second direction; and a front dam for engaging vertical surfaces of a second group of containers, the front dam comprising a second tarp having first and second surfaces, the second tarp comprising a second rigid restraint structure, affixed to one of the first and second surfaces of the second tarp, for maintaining the second tarp against the vertical surfaces of the first group of containers against a force biasing the second tarp away from the second group of containers as air is forced through the plurality of containers in the second direction.

In a further example, the present technology relates to a method of cooling perishable goods within a plurality of containers, comprising: (a) forcing air through the plurality of containers in a first direction; (b) covering exposed surfaces of the plurality of containers with a tarp to prevent bypass of air around the exposed surfaces of the plurality of containers; (c) restraining the containers against movement due to a pressure differential on opposite sides of the containers as air is forced though the containers in the first direction in said step (a); (d) forcing air through the containers in a second direction opposite the first direction, the air flow in the second direction biasing the tarp away from the containers; and (e) restraining the tarp from moving away from the containers upon air flow in the second direction in said step (d).

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. An apparatus for cooling perishable goods within a plurality of containers, the goods cooled by cooled air forced through the containers, the apparatus comprising:
a tarp having first and second surfaces, the tarp comprising:
a wedge, affixed to one of the first and second surfaces of the tarp, for engaging a portion of one or more containers to support the plurality of containers against movement due to a pressure differential on opposed sides of the plurality of containers, and
a rigid restraint structure, affixed to one of the first and second surfaces of the tarp, for maintaining the tarp against the one or more containers against a force biasing the tarp away from the one or more containers.

2. The apparatus of claim 1, wherein the wedge supports the plurality of containers against movement as air is forced through the plurality of containers in a first direction.

3. The apparatus of claim 2, the rigid restraint structure maintaining the tarp against the one or more containers as air is forced through the plurality of containers in a second direction opposite the first direction.

4. The apparatus of claim 1, the rigid restraint structure comprising a plurality of rigid rods affixed at intervals along a length of the tarp.

5. The apparatus of claim 1, further comprising a framing member, the tarp being affixed at its edges to the framing member.

6. The apparatus of claim 1, wherein the tarp is configured to engage top horizontal surfaces of the plurality of containers.

7. The apparatus of claim 1, wherein the tarp is configured to engage vertical surfaces of the plurality of containers.

8. The apparatus of claim 1, wherein the tarp comprises a top tarp, and the rigid restraint structure comprises a first rigid restraint structure, wherein the top tarp is configured to engage with top horizontal surfaces of the plurality of containers, the apparatus further comprising a front tarp comprising a second rigid restraint structure configured to engage with vertical surfaces of the plurality of containers.

9. The apparatus of claim 1, wherein the tarp comprises a top tarp, and the rigid restraint structure comprises a first rigid restraint structure, wherein the top tarp is configured to engage with top horizontal surfaces of the plurality of containers, the apparatus further comprising a front tarp comprising a second rigid restraint structure configured to engage with vertical surfaces of the plurality of containers.

10. The apparatus of claim 9, wherein the second rigid restraint structure comprises a plurality of rigid rods, affixed to one of the first and second surfaces of the tarp, for maintaining the second tarp against the vertical surfaces of the containers against a force biasing the second tarp away from the containers.

11. The apparatus of claim 1, wherein the plurality of containers are stacked on pallets, the apparatus further comprising pallet dams which is movable into engagement with the pallets to prevent air flow through the pallets.

12. The apparatus of claim 11, wherein the pallet dam is movable between first and second positions, corresponding to first and second pallet heights used within the apparatus.

13. An apparatus for cooling perishable goods within containers, the containers stacked in two groups, each group including rows and columns of containers, the two groups of containers defining a central space between the two groups of containers, the goods cooled by cooled air forced through the containers in the two groups of containers, the apparatus comprising:
a tarp having first and second surfaces, the tarp comprising:
first and second wedges, affixed to one of the first and second surfaces of the tarp, for engaging a portion of one or more containers in each of the two groups of containers, the first and second wedges operable to support the containers in the two groups against movement into the central space due to a pressure differential on opposed sides of the two groups of containers, and
a rigid restraint structure, affixed to one of the first and second surfaces of the tarp, for maintaining the tarp against the one or more containers in each of the two groups against a force biasing the tarp away from the one or more containers in the two groups.

14. The apparatus of claim 13, the rigid restraint structure comprising a plurality of rigid rods affixed at intervals along a length of the tarp.

15. The apparatus of claim 13, wherein the tarp is configured to engage top horizontal surfaces of the two groups of containers, and cover an open top of the central space.

16. The apparatus of claim 13, wherein the tarp is configured to engage vertical surfaces of the two groups of containers and cover an open side of the central space.

17. The apparatus of claim 13, wherein the tarp comprises a top tarp, and the rigid restraint structure comprises a first rigid restraint structure, wherein the top tarp is configured to engage with top horizontal surfaces of the two groups of containers and cover an open top of the central space, the apparatus further comprising a front tarp comprising a second rigid restraint structure configured to engage with vertical surfaces of the plurality of containers and cover an open side of the central space.

18. The apparatus of claim 13, wherein the tarp comprises a top tarp, and the rigid restraint structure comprises a first rigid restraint structure, wherein the top tarp is configured to engage with top horizontal surfaces of the plurality of containers, the apparatus further comprising a front tarp comprising a second rigid restraint structure configured to engage with vertical surfaces of the plurality of containers.

19. The apparatus of claim 13, wherein the two groups of containers are stacked on pallets, the apparatus further comprising pallet dams which are movable into engagement with the pallets of the two groups to prevent air flow through the pallets.

20. The apparatus of claim 19, wherein the pallet dams are movable between first and second positions, corresponding to first and second pallet heights used within the apparatus.

21. An apparatus for cooling perishable goods within a plurality of containers, the goods cooled by cooled air forced in a first direction through the containers in a first mode of operation, and the cooled air forced in a second direction through the containers, opposite the first direction, in a second mode of operation, the apparatus comprising:
a top dam for engaging horizontal surfaces of a first group of containers, the top dam comprising a first tarp having first and second surfaces, the first tarp comprising:
a wedge, affixed to one of the first and second surfaces of the tarp, for engaging a portion of the first group of one or more containers to support the plurality of containers against movement due to a pressure differential on opposed sides of the plurality of containers as air is forced through the plurality of containers in the first direction, and
a first rigid restraint structure, affixed to one of the first and second surfaces of the first tarp, for maintaining the first tarp against the horizontal surfaces of the first group of containers against a force biasing the first tarp away from the first group of containers as air is forced through the plurality of containers in the second direction; and
a front dam for engaging vertical surfaces of a second group of containers, the front dam comprising a second tarp having first and second surfaces, the second tarp comprising a second rigid restraint structure, affixed to one of the first and second surfaces of the second tarp, for maintaining the second tarp against the vertical surfaces of the first group of containers against a force biasing the second tarp away from the second group of containers as air is forced through the plurality of containers in the second direction.

22. The apparatus of claim 21, wherein the front dam is pivotally affixed to the top dam.

23. The apparatus of claim 21, wherein the plurality of containers are stacked on pallets, the apparatus further comprising pallet dams which is movable into engagement with the pallets to prevent air flow through the pallets.

24. The apparatus of claim 23, wherein the pallet dam is movable between first and second positions, corresponding to first and second pallet heights used within the apparatus.

25. The apparatus of claim 21, wherein the top and front dams may be moved between a stowed position where the plurality of containers may be loaded into the apparatus and a deployed position where the top and front dams engage the plurality of containers.

26. The apparatus of claim 21, further comprising a structural frame supporting the top and front dams, the structural frame being adjustable to accommodate different size loads of containers.

27. A method of cooling perishable goods within a plurality of containers, comprising:
(a) forcing air through the plurality of containers in a first direction;
(b) covering exposed surfaces of the plurality of containers with a tarp to prevent bypass of air around the exposed surfaces of the plurality of containers;
(c) restraining the containers against movement due to a pressure differential on opposite sides of the containers as air is forced though the containers in the first direction in said step (a);
(d) forcing air through the containers in a second direction opposite the first direction, the air flow in the second direction biasing the tarp away from the containers; and
(e) restraining the tarp from moving away from the containers upon air flow in the second direction in said step (d).

28. The method of claim 27, said step (c) of restraining the containers against movement due to a pressure differential on opposite sides of the containers comprises the step of affixing a wedge to the tarp, the wedge engaging vertical portions of the plurality of containers.

29. The method of claim 27, said step (d) of restraining the tarp from moving away from the containers comprises the step of affixing a rigid restraint structure to the tarp, the rigid restraint structure holding the tarp against the plurality of containers.

30. The method of claim 27, said step (d) of restraining the tarp from moving away from the containers comprises the step of affixing a plurality of rigid rods at intervals along a length of the tarp, the rigid rods holding the tarp against the plurality of containers.

31. The method of claim 27, the plurality of containers supported on pallets, the method further comprising the step of covering openings in the pallets to prevent bypass of air through the openings in the pallets.
